(19) United States
(12) Patent Application Publication
(10) Pub. No.: US 2006/0112691 A1
(43) Pub. Date: Jun. 1, 2006

(54) Method of generating power from naturally occurring heat without fuels and motors using the same

(76) Inventor: Wen-Show Ou, Kaohsiung (TW)

Correspondence Address: PAI PATENT & TRADEMARK LAW FIRM, 1001 FOURTH AVENUE, SUITE 3200, SEATTLE, WA, 98154, US

(21) Appl. No.: 11/062,397

(22) Filed: Feb. 22, 2005

(30) Foreign Application Priority Data
Nov. 29, 2004 (TW) 093136744

(51) Int. Cl. F03G 7/00; B60K 16/00; F03G 6/00; B60L 8/00

(52) U.S. Cl. 60/641.2; 60/641.8

(57) ABSTRACT

A method of generating power is disclosed wherein a liquid having a normal boiling point near the ambient temperature is placed in a pressure vessel, heat energy is gathered from a naturally occurring heat sources, such as by solar collectors or from hot springs, geothermal or other heat sources, and transmitted through conduction heat pipes to the liquid in the pressure vessel, and the liquid is thereby heated to the boiling point and vaporized. When a liquid is vaporized, its volume expands by several hundred times, creating a pressure sufficient for driving motors. This invention can be used in automobiles, motorcycles, generators, ships, homes, factories, and other suitable places to drive motors, thus reducing the use of petrochemical fuels.

### BACKGROUND OF THE INVENTION

1. Field of the Invention

This invention relates to a method of generating power from naturally occurring heat energy without consuming fuels, and to the motors using the method. More particularly, this invention relates to a method of generating power by vaporizing a liquid in a pressure vessel using solar energy, geothermal energy or other types of naturally occurring heat energy, wherein the boiling point of the liquid is near the ambient temperature.

2. Description of the Related Art

Power used by humans is mostly derived from combustion of fuels, which exacerbates the greenhouse effect and El Niño, threatening the existence of humans. Therefore, effective utilization of clean energy, such as solar energy, geothermal energy, or energy derived from hot springs or any other suitable heat sources. has been a long-standing goal pursued by many researchers. This invention has arisen from pursuing this goal.

### BRIEF SUMMARY OF THE INVENTION

The invention essentially comprises gathering heat energy from naturally occurring heat sources (such as solar energy, geothermal energy, hot springs, or other natural heat-producing sources), quickly transmitting the heat energy through conduction heat pipes to a liquid-vapor two-phase system contained in a pressure vessel, heating the liquid-vapor system to its boiling point to vaporize the liquid and generate a high pressure from volumetric expansion when the liquid is converted to vapor, and applying the high pressure to drive motors. In principle, it works in the same way as steam drives a steam engine. For the present invention to work effectively, the boiling point of the liquid should be near the ambient temperature. This invention can be applied in automobiles, motorcycles, generators, ships, homes, factories and other suitable places to drive motors. Thus, the invention can help reduce the consumption of fossil fuels and petrochemicals.

### BRIEF DESCRIPTION OF THE DRAWINGS

FIG. 1 shows the first embodiment of the present invention wherein the high-pressure vapor passes through a jet nozzle to drive turbine vanes.

FIG. 2 shows the second embodiment of the present invention wherein the high-pressure vapor drives a piston connected to a motor.

### DETAILED DESCRIPTION OF THE PREFERRED EMBODIMENTS

The present invention is described in detail below through two embodiments along with the accompanying drawings.

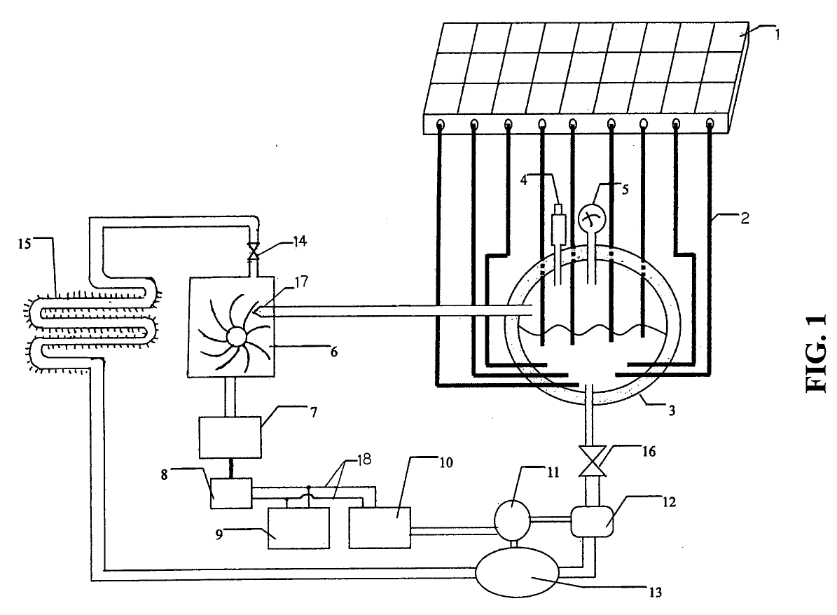

Referring to FIG. 1, this invention uses solar collectors 1 to gather solar heat energy, which is transmitted through conduction heat pipes 2 to a liquid-vapor two-phase system contained in a pressure vessel 3. The pressure vessel 3 is equipped with a safety valve 4 and a pressure gauge 5 for protection from excessive pressure. When the heat transmitted from the solar collectors heats the liquid inside the pressure vessel 3 to its boiling point, the liquid is converted to vapor, expanding the volume by several hundred times and generating a pressure of several hundred atmospheres. Such high pressure is sufficient to drive a motor 6. After driving the motor 6, the vapor at reduced pressure passes through a first check valve 14 and enters a cooler 15; after exiting the cooler 15, the vapor cools down below the boiling point and condenses into liquid, which then enters a reservoir 13 to be pumped by a pump 12 through a second check valve 16 back to the pressure vessel 3, thus completing the cycle. The pump 12 is connected to a liquid level controller 11 for the reservoir 13, and the liquid level controller 11 is connected to a control box 10, which controls the operation of both the pump 12 and the liquid level controller 11.

Beside carrying a load 7, the above-mentioned motor 6 also drives a generator 8. In turn, the generator 8 is connected through wires 18 to a battery 9 and the control box 10. The generator 8 and the battery 9 provide electricity for operating the pump 12 and the control box 10. As shown in FIG. 1, the motor 6 can be powered by allowing the high-pressure vapor pass through a jet nozzle 17 to drive a series of turbine vanes.

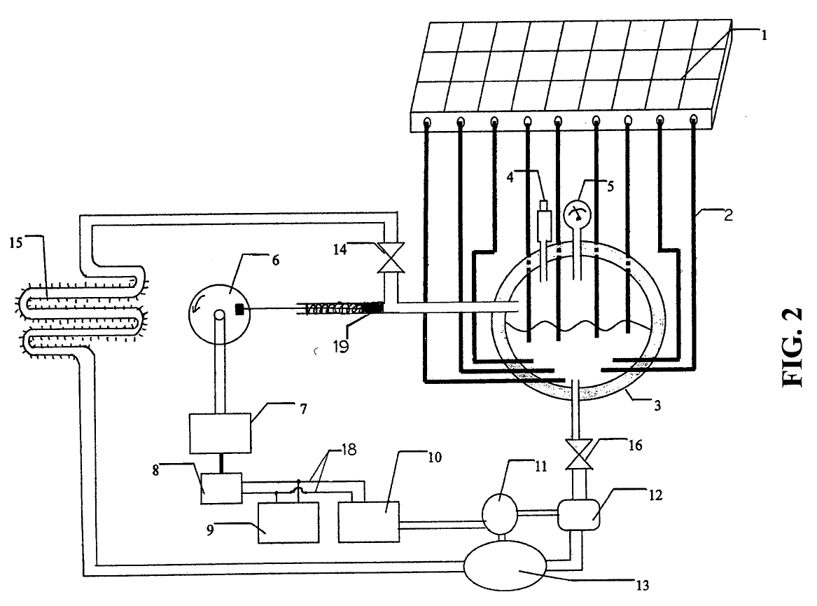

FIG. 2 illustrates a second embodiment of the present invention. This embodiment is identical to the first embodiment shown in FIG. 1, except that the high-pressure vapor drives a piston 19 to power the motor 6. One should note that other types of driving mechanisms can be used instead.

The above-mentioned motor 8 can also be used for electrolysis of water to produce hydrogen for various applications.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

I claim:

1. A method of generating power from naturally occurring heat sources without fuels, comprising the steps of:
(a) placing a liquid in a pressure vessel to form a liquid-vapor two-phase system, wherein the boiling point of the liquid is substantially near ambient temperature;
(b) gathering heat energy from a naturally occurring heat source;
(c) transmitting the heat energy gathered in step (b) to the liquid-vapor two-phase system to heat it to the boiling point of the liquid to vaporize the liquid and generate a high-pressure vapor; and
(d) using the high-pressure vapor generated in step (c) to drive a motor.

2. The method as claimed in claim 1, further comprising the steps of:
(e) passing the vapor after driving the motor through a first check valve and through a pipe to a cooler;
(f) cooling the vapor entering the cooler to below the boiling point of the liquid and converting it to liquid;
(g) passing the liquid from step (f) to a reservoir; and
(h) returning the liquid from the reservoir through a second check valve to the pressure vessel to form a complete cycle using a pump connected to a liquid level controller for the reservoir.

3. The method as claimed in claim 2, wherein
conduction heat pipes are used in step (c) to transmit the heat energy gathered in step (b) to the liquid-vapor two-phase system; and
the pressure vessel is equipped with a safety valve and a pressure gauge.

4. The method as claimed in claim 3, wherein
the motor is of a piston type or a turbine type.

5. The method as claimed in claim 3, wherein
the high-pressure vapor flows through a jet nozzle to drive the motor in step (d).

6. The method as claimed in claim 3, wherein
the motor drives a generator in addition to a load; and
the generator is wired to a battery and a control box of the pump for the purpose of controlling the operation of the liquid level controller and the pump.

7. The method as claimed in claim 6, wherein
the generator is further used for electrolysis of water to produce hydrogen.

8. The method as claimed in claim 1, wherein
solar collectors are used to gather heat energy in step (b).

9. The method as claimed in claim 1, wherein
heat energy is gathered from a geothermal energy source in step (b).

10. The method as claimed in claim 1, wherein
heat energy is gathered from a hot spring in step (b).

11. A method of generating power from naturally occurring heat sources without fuels, comprising the steps of:
(a) placing a liquid in a pressure vessel to form a liquid-vapor two-phase system, wherein the boiling point of the liquid is substantially near ambient temperature;
(b) gathering heat energy from a heat source;
(c) transmitting the heat energy gathered in step (b) to the liquid-vapor two-phase system to heat it to the boiling point of the liquid to vaporize the liquid and generate a high-pressure vapor; and
(d) using the high-pressure vapor generated in step (c) to drive a motor.
